(19) United States
(12) Patent Application Publication
(10) Pub. No.: US 2009/0021656 A1
(43) Pub. Date: Jan. 22, 2009

(54) EXPOSURE METHOD AND APPARATUS

(75) Inventor: Takao Ozaki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/814,745

(22) PCT Filed: Jan. 24, 2006
(86) PCT No.: PCT/JP2006/301386

§ 371 Date: Jul. 25, 2007

(30) Foreign Application Priority Data
Jan. 25, 2005 (JP) 2005-016448

(51) Int. Cl. G02F 1/1335; G03B 27/52

(52) U.S. Cl. 349/4; 355/67

(57) ABSTRACT

When an image of a two-dimensional pattern is formed on a photosensitive material by performing spatial light modulation on light emitted from a light source by a spatial light modulation means including a multiplicity of arranged pixel units and by forming an image by a second imaging optical system after forming an image of each of light beams corresponding to the pixel units, on which the spatial light modulation has been performed, by a first imaging optical system, the imaging position of each of light beams is controlled separately for each of the light beams. Accordingly, the image of the two-dimensional pattern formed on the photosensitive material coincides with an intended two-dimensional pattern.

### TECHNICAL FIELD

The present invention relates to an exposure method and apparatus. Particularly, the present invention relates to an exposure method and apparatus for exposing a photosensitive material to light by forming an image of a two-dimensional pattern on the photosensitive material. The image of the two-dimensional pattern is formed by performing spatial light modulation on light emitted from a light source by reflecting the light by a multiplicity of pixel units and by forming an image of each of light beams corresponding to the pixel units.

### BACKGROUND ART

Conventionally, an exposure apparatus for producing printed circuit boards by exposing a photosensitive material deposited on a surface of a substrate to light is well known. In the exposure apparatus, the photosensitive material is exposed to light by forming an image on the photosensitive material with laser light on which spatial light modulation has been performed. The exposure apparatus includes a light source, a DMD (digital micromirror device), which is a spatial light modulation means for performing spatial light modulation on laser light emitted from the light source, and an imaging optical system for forming an image of the laser light on which spatial light modulation has been performed by the DMD. The DMD is a device produced using a semiconductor production process. In the DMD, a multiplicity of micromirrors are two-dimensionally arranged on a semiconductor substrate, made of silicon or the like, and the angle of the reflection surface of each of the micromirrors is changed based on a control signal input from the outside. The DMD performs spatial light modulation by reflecting incident light by the multiplicity of micromirrors.

The exposure apparatus can directly form (project) an image of a circuit pattern obtained by performing spatial light modulation on laser light at the DMD on a photosensitive material. Therefore, it is possible to produce printed circuit boards without using a light shield mask or the like (please refer to Akihito Ishikawa, “Shortening Development and Adaptation to Mass Production by Maskless Exposure”, Electronics Mounting Technology, Gicho Publishing & Advertising Co., Ltd., Vol. 18, No. 6, 2002, pp. 74-79, and Japanese Unexamined Patent Publication No. 2004-001244).

Further, each of light beams that have entered the DMD, and on which spatial light modulation has been performed by the multiplicity of micromirrors, the light beams corresponding to the micromirrors, is passed through an imaging optical system to form an image, thereby forming an image of a circuit pattern on the photosensitive material. When the image of the circuit pattern is formed, the imaging position of each of the light beams is shifted in some cases. The imaging position is shifted in the direction of the light axis of an optical path for forming the image of the circuit pattern or in a direction orthogonal to the direction of the light axis because of a shift or misalignment in the position of an optical part, such as the DMD and the imaging optical system. As a method for correcting such a shift in the position, a method for forming an image of a circuit pattern on the photosensitive material by performing spatial light modulation using the DMD in such a manner that the shift in the imaging position is taken into consideration in advance has been proposed (please refer to Japanese Unexamined Patent Publication No. 2003-057834).

However, the method in which the spatial light modulation is performed in such a manner that the shift in the imaging position of each of the light beams is taken into consideration is not always an efficient method because it is necessary to generate a new control signal for controlling the DMD. Therefore, there is a demand for more easily correcting the imaging position of each of the light beams without generating a new control signal.

In view of the foregoing circumstances, it is an object of the present invention to provide an exposure method and apparatus for more easily correcting the imaging position of each of light beams when an image of a two-dimensional image is formed on a photosensitive material.

### DISCLOSURE OF THE INVENTION

A first exposure method of the present invention is an exposure method for exposing a photosensitive material to light in an intended two-dimensional pattern, the method comprising the steps of:

performing spatial light modulation on light, the light being emitted from a light source, by a spatial light modulation means including a multiplicity of two-dimensionally-arranged pixel units for modulating incident light based on a predetermined control signal;

forming an image of each of light beams corresponding to the pixel units, on which the spatial light modulation has been performed by the spatial light modulation means, by passing each of the light beams through a first imaging optical system;

passing each of the light beams separately through a multiplicity of two-dimensionally-arranged microlenses respectively in the vicinity of the imaging position of each of the light beams, the image of which was formed by passing each of the light beams through the first imaging optical system; and

forming an image of a two-dimensional pattern on the photosensitive material by forming an image of each of the light beams passed separately through the respective microlenses on the photosensitive material by a second imaging optical system, the method characterized in that the imaging position of each of the light beams by the first imaging optical system and/or the second imaging optical system is controlled separately for each of the light beams so that the image of the two-dimensional pattern formed on the photosensitive material coincides with the intended two-dimensional pattern.

A second exposure method of the present invention is an exposure method for exposing a photosensitive material to light in an intended two-dimensional pattern, the method comprising the steps of:

performing spatial light modulation on light, the light being emitted from a light source, by a spatial light modulation means including a multiplicity of two-dimensionally-arranged pixel units for modulating incident light based on a predetermined control signal;

forming an image of each of light beams corresponding to the pixel units, on which the spatial light modulation has been performed by the spatial light modulation means, by passing each of the light beams through a first imaging optical system;

passing each of the light beams separately through a multiplicity of two-dimensionally-arranged microlenses respectively in the vicinity of the imaging position of each of the light beams, the image of which was formed by passing each of the light beams through the first imaging optical system, so as to directly form an image of each of the light beams on the photosensitive material, thereby forming an image of a two-dimensional pattern on the photosensitive material, the method characterized in that the imaging position of each of the light beams by the first imaging optical system is controlled separately for each of the light beams so that the image of the two-dimensional pattern formed on the photosensitive material coincides with the intended two-dimensional pattern.

A first exposure apparatus of the present invention is an exposure apparatus for exposing a photosensitive material to light in an intended two-dimensional pattern, the projection exposure apparatus comprising:

a light source;

a spatial light modulation means for performing spatial light modulation on light emitted from the light source, the spatial light modulation means including a multiplicity of two-dimensionally-arranged pixel units for modulating the light based on a predetermined control signal;

a first imaging optical system for forming an image of each of light beams corresponding to the pixel units, on which the spatial light modulation has been performed by the spatial light modulation means;

a microlens array including a multiplicity of two-dimensionally-arranged microlenses for separately passing each of the light beams, each of the microlenses being placed in the vicinity of the imaging position of each of the light beams, the image of which was formed by passing each of the light beams through the first imaging optical system; and

a second imaging optical system for forming an image of a two-dimensional pattern on the photosensitive material by forming an image of each of the light beams passed separately through the respective microlenses on the photosensitive material, the apparatus characterized by further comprising:

an imaging position control means for controlling the imaging position of each of the light beams, the imaging position by the first imaging optical system and/or the second imaging optical system, separately for each of the light beams so that the image of the two-dimensional pattern formed on the photosensitive material coincides with the intended two-dimensional pattern.

The imaging position control means may move the imaging position of each of the light beams in the direction of the light axis of an optical path for forming the image of the two-dimensional pattern on the photosensitive material or in a direction orthogonal to the direction of the light axis.

A second exposure apparatus of the present invention is an exposure apparatus for exposing a photosensitive material to light in an intended two-dimensional pattern, the projection exposure apparatus comprising:

a light source;

a spatial light modulation means for performing spatial light modulation on light emitted from the light source, the spatial light modulation means including a multiplicity of two-dimensionally-arranged pixel units for modulating the light based on a predetermined control signal;

a first imaging optical system for forming an image of each of light beams corresponding to the pixel units, on which the spatial light modulation has been performed by the spatial light modulation means, and

a microlens array including a multiplicity of two-dimensionally-arranged microlenses for separately passing each of the light beams, each of the microlenses being placed in the vicinity of the imaging position of each of the light beams, the image of which was formed by passing each of the light beams through the first imaging optical system, wherein an image of a two-dimensional pattern is formed on the photosensitive material by directly forming an image of each of the light beams passed separately through the respective microlenses on the photosensitive material, the apparatus characterized by further comprising:

an imaging position control means for controlling the imaging position of each of the light beams, the imaging position by the first imaging optical system, separately for each of the light beams so that the image of the two-dimensional pattern formed on the photosensitive material coincides with the intended two-dimensional pattern.

The imaging position control means may move the imaging position of each of the light beams in the direction of the light axis of an optical path for forming the image of the two-dimensional pattern on the photosensitive material or in a direction orthogonal to the direction of the light axis.

The imaging position control means may be a liquid crystal device, wherein a distribution of refractive indices is generated in the liquid crystal device by electrical control.

The expression “the image of the two-dimensional pattern formed on the photosensitive material coincides with the intended two-dimensional pattern” refers to causing at least one of the position, the size and the density of each of pixels forming the image of the two-dimensional pattern to coincide with that of respective pixels forming the intended two-dimensional pattern, the respective pixels corresponding to the pixels forming the image of the two-dimensional pattern. Further, it is desirable that in the image of the two-dimensional pattern formed on the photosensitive material, all of the position, the size and the density of each of the pixels forming the image of the two-dimensional pattern coincide with those of respective pixels forming the intended two-dimensional pattern, the respective pixels corresponding to the pixels forming the image of the two-dimensional pattern.

In the first exposure method and apparatus of the present invention, the imaging position of each of light beams by the first imaging optical system and/or the second imaging optical system is controlled separately for each of the light beams so that an image of a two-dimensional pattern formed on the photosensitive material coincides with an intended two-dimensional pattern. Therefore, it is possible to more easily correct the imaging position of each of the light beams, for example, without generating a new control signal for controlling the spatial light modulation means or the like. Further, since the imaging positions of the light beams are corrected separately for each of the light beams, it is possible to smooth a variation in an exposure light amount at an edge portion forming the outline of a two-dimensional pattern formed on the photosensitive material, for example. Alternatively, it is possible to form an image of each of the light beams on the photosensitive material by shifting the position of each of the light beams.

In the second exposure method and apparatus of the present invention, the imaging position of each of light beams by the first imaging optical system is controlled separately for each of the light beams so that an image of a two-dimensional pattern formed on the photosensitive material coincides with an intended two-dimensional pattern. Therefore, it is possible to more easily correct the imaging position of each of the light beams, for example, without generating a new control signal for controlling the spatial light modulation means or the like. Further, since the imaging positions of the light beams are corrected separately for each of the light beams, it is possible to smooth a variation in an exposure light amount at an edge portion forming the outline of a two-dimensional pattern formed on the photosensitive material, for example. Alternatively, it is possible to form an image of each of the light beams on the photosensitive material by shifting the position of each of the light beams.

Further, if the imaging position control means is a means for moving the imaging position of each of the light beams in the direction of the light axis of an optical path for forming an image of a two-dimensional pattern on the photosensitive material or in a direction orthogonal to the direction of the light axis, it is possible to more accurately move the imaging position of each of the light beams. Therefore, it is possible to more accurately control the imaging position of each of the light beams.

Further, if the imaging position control means is a liquid crystal device, in which a distribution of refractive indices is generated by electrical control, it is possible to move the imaging position of each of light beams without mechanically moving optical parts. Therefore, it is possible to more easily control the imaging position of each of the light beams.

### BRIEF DESCRIPTION OF THE DRAWINGS

FIG. 1 is a diagram illustrating an optical path of an optical system of an exposure head included in an exposure apparatus according to an embodiment of the present invention;

FIG. 2 is a schematic perspective view illustrating the configuration of the optical system of the exposure head;

FIG. 3 is a diagram illustrating an enlarged view of a polarization unit for causing the polarization direction of light emitted from a light source to become uniform;

FIG. 4 is a partial enlarged diagram of a multiplicity of two-dimensionally-arranged micromirrors;

FIG. 5A is a diagram illustrating an operation for reflecting light by a micromirror;

FIG. 5B is a diagram illustrating an operation for reflecting light by a micromirror inclined at an angle different from the angle of the micromirror illustrated in FIG. 5A;

FIG. 6A is a diagram illustrating an example of a used area of a multiplicity of arranged micromirrors;

FIG. 6B is a diagram illustrating another example of a used area of the multiplicity of arranged micromirrors, which is different from the example illustrated in FIG. 6A;

FIG. 7 is a schematic enlarged perspective view illustrating the configuration of a first imaging position correction unit;

FIG. 8A is a diagram illustrating a part of a shift-direction correction device, viewed from the upstream side of an optical path through which a light beam propagates;

FIG. 8B is a diagram illustrating a cross section of FIG. 8A;

FIG. 8C is a diagram illustrating a cross section of FIG. 8A, which is different from the cross section illustrated in FIG. 8B;

FIG. 9A is a diagram illustrating a part of a focus-direction correction device, viewed from the upstream side of an optical path of a light beam;

FIG. 9B is a diagram illustrating a cross section of FIG. 9A;

FIG. 10 is a schematic enlarged perspective view illustrating the configuration of a second imaging position correction unit;

FIG. 11 is a diagram illustrating an external perspective view of the exposure apparatus;

FIG. 12 is a perspective view illustrating the process of exposing a photosensitive material to light using an exposure head;

FIG. 13A is a plan view illustrating an exposure area formed on a photosensitive material;

FIG. 13B is a diagram illustrating a positional relationship between exposure areas by respective exposure heads;

FIG. 14 is a block diagram illustrating the electrical configuration of the exposure apparatus; and

FIG. 15 is a diagram illustrating an optical path of an optical system of an exposure head included in an exposure apparatus according to an embodiment of the present invention.

### BEST MODE FOR CARRYING OUT THE INVENTION

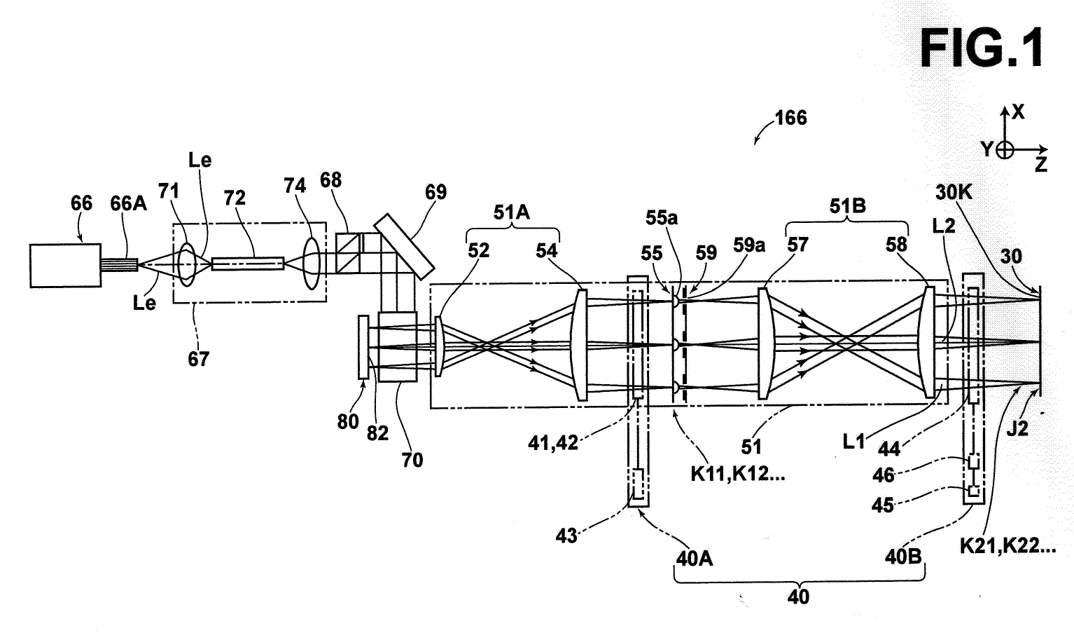

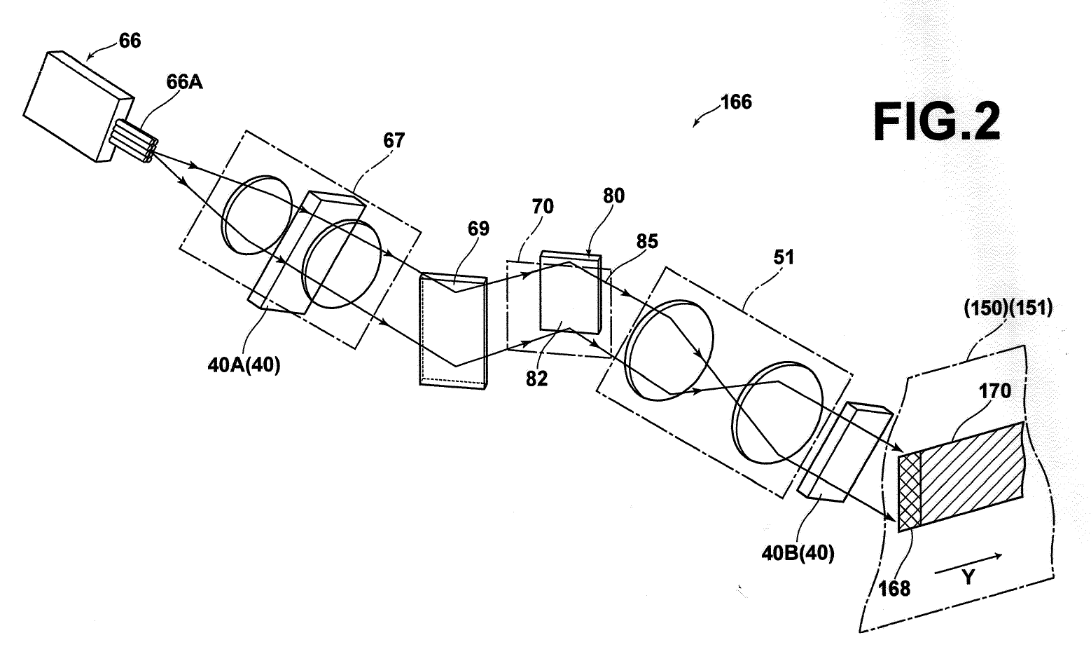

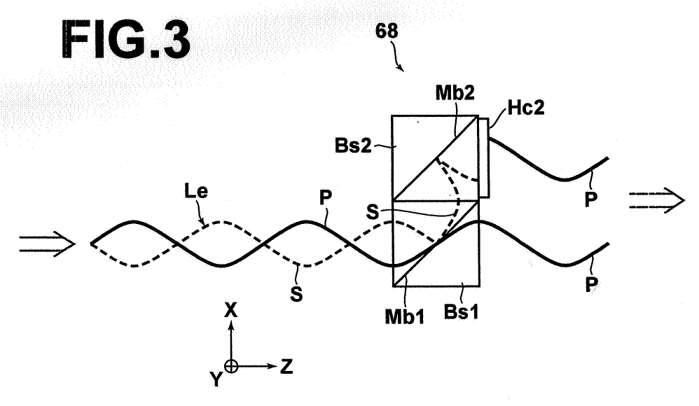

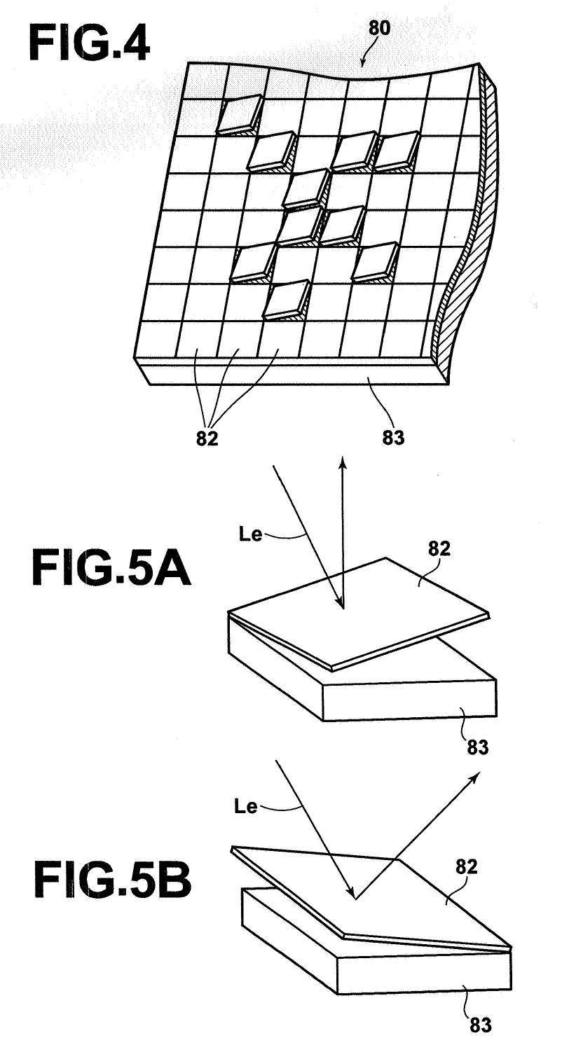

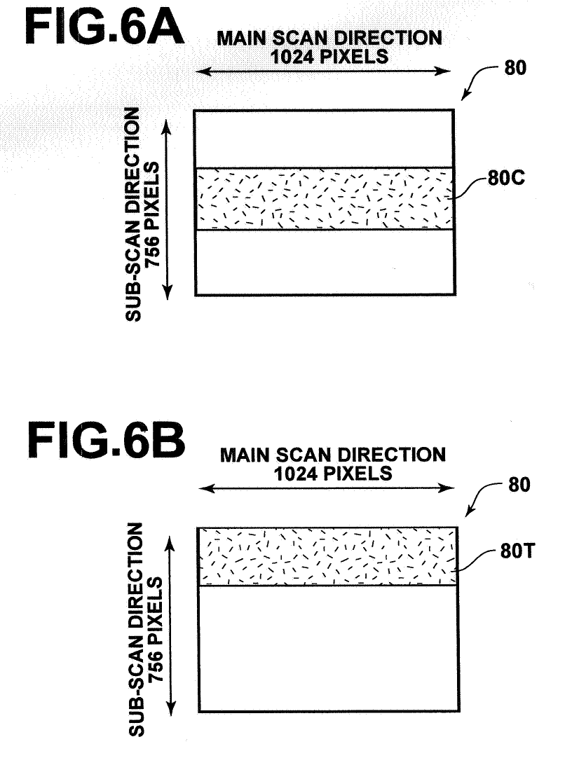

Hereinafter, a first embodiment of the present invention will be described with reference to the drawings. FIG. 1 is a diagram illustrating an optical path of an optical system of an exposure head included in an exposure apparatus. FIG. 2 is a schematic perspective view illustrating the configuration of the optical system. FIG. 3 is a diagram illustrating the process in which a polarization unit causes the polarization direction of laser light emitted from a light source to become uniform. FIG. 4 is a partial enlarged diagram of a multiplicity of two-dimensionally-arranged micromirrors. FIGS. 5A and 5B are diagrams illustrating operations for reflecting light by micromirrors. FIGS. 6A and 6B are diagrams illustrating examples of used areas of micromirrors in a DMD.

An exposure apparatus that carries out an exposure method of the present invention is used to produce printed circuit boards. The exposure apparatus exposes a material for printed circuit boards, the material being formed by depositing a photosensitive material on a substrate, to light in a circuit pattern, which is a two-dimensional pattern.

An exposure head 166 of the exposure apparatus includes a light source 66 and a DMD 80 for performing spatial light modulation on laser light Le, emitted from the light source 66. The DMD includes a multiplicity of two-dimensionally-arranged micromirrors 82, which are pixel units for modulating the laser light Le based on a predetermined control signal. Further, the exposure head 166 includes a first imaging optical system 51A, a microlens array 55, a second imaging optical system 51B and an imaging position correction means 40. The first imaging optical system 51A forms an image of each of light beams L1, L2 . . . , corresponding to the micromirrors 82. The light beams L1, L2 . . . are light beams on which spatial light modulation has been performed by the DMD 80. The microlens array 55 includes two-dimensionally-arranged microlenses 55a, which pass the light beams L1, L2 . . . separately. Each of the microlenses 55a is placed in the vicinity of the imaging position of each of the light beams L1, L2 . . . , each being formed into an image by the first imaging optical system 51A. The second imaging optical system 51B forms an image J2 of a two-dimensional pattern on a photosensitive material 30K by forming an image of each of the light beams one more time on the photosensitive material 30K, the light beams having passed separately through the microlenses 55a. The imaging position correction means 40 is an imaging position control means for correcting imaging positions K11, K12 . . . of the light beams L1, L2 . . . , the imaging positions K11, K12 . . . by the first imaging optical system 51A, separately for each of the light beams L1, L2 . . . . Each of the imaging positions K11, K12 . . . of the light beams L1, L2 . . . is corrected so that the image J2 of the two-dimensional pattern formed on the photosensitive material 30K coincides with an intended two-dimensional pattern. Further, the imaging position control means corrects imaging positions K21, K22 . . . of the light beams L1, L2 . . . , the imaging positions K21, K22 . . . by the second imaging optical system 51B, separately for each of the light beams L1, L2 . . . . Each of the imaging positions K21, K22 . . . of the light beams L1, L2 . . . is corrected so that the image J2 of the two-dimensional pattern formed on the photosensitive material 30K coincides with the intended two-dimensional pattern.

It is desirable that the first imaging optical system 51 and the second imaging optical system 51B are optical systems that are telecentric on the image side.

Further, the exposure head 166 includes a light-intensity distribution correction optical system 67, a polarization unit 68, a mirror 69 and a TIR (total reflection) prism 70. The light-intensity distribution correction optical system 67 receives the laser light Le emitted from the light source 66, corrects the laser light Le so that the laser light Le has substantially uniform light-intensity distribution, and emits the corrected laser light Le. The polarization unit 68 passes the laser light Le emitted from the light-intensity distribution correction optical system 67 and causes the polarization direction of the laser light Le to become uniform. The mirror 69 bends the direction of an optical path by reflecting the laser light emitted from the polarization unit 68. The TIR prism 70 totally reflects the laser light reflected by the mirror 69 and causes the laser light to enter the DMD 80. Further, the TIR prism 70 transmits each of light beams emitted from the DMD 80, on which spatial light modulation has been performed by the DMD 80.

### <<Explanation of Each Composition Element Forming Exposure Apparatus>>

### <Light Source 66>

The light source 66 includes a plurality of wave-combination units (not illustrated) for combining laser beams emitted from a plurality of GaN-based semiconductor lasers that emit light having a wavelength of 405 nm. Each of the wave-combination units combines the laser beams by inputting the laser beams in one optical fiber for combining waves. The light source 66 emits laser light having the wavelength of 405 nm from an optical fiber bundle 66A, which is formed by bundling a plurality of optical fibers for combining waves in the wave-combination units. Further, it is not necessary that the light emitted from the light source 66 is laser light having the wavelength of 405 nm. The light emitted from the light source 66 may be light having any wavelength or light generated by using any kind of method as long as the photosensitive material 30K can be exposed to light.

### <Light-Intensity Distribution Correction Optical System 67>

The light-intensity distribution correction optical system 67 includes a condensing lens 71, a rod integrator 72 and a collimating lens 74, as illustrated in FIG. 1. The condensing lens 71 condenses laser light Le emitted from the optical fiber bundle 66A of the light source 66. The rod integrator 72, which will be described later, is inserted in the optical path of the laser light Le that has been transmitted through the condensing lens 71. The collimating lens 74 is placed on the downstream side of the rod integrator 72. In other words, the collimating lens 74 is placed on the mirror-69-side of the rod integrator 72. The rod integrator 72 receives the laser light Le from one end thereof and emits the laser light Le from the other end thereof so that the light-intensity distribution of the laser light Le at a cross section of the beam becomes more uniform. Accordingly, the laser light Le emitted from the optical fiber bundle 66A and transmitted through the light-intensity distribution correction optical system 67 becomes a collimated light beam having a substantially uniform light-intensity distribution at a cross section thereof.

### <Polarization Unit 68>

As illustrated in FIG. 3, the polarization unit 68 includes prism-type polarization beam splitters Bs1 and Bs2 and a ½ wavelength plate Hc2. Each of the polarization beam splitters Bs1 and Bs2 includes two right-angle prisms attached to each other. The polarization beam splitters Bs1 and Bs2 transmit p-polarization and reflect s-polarization. The polarization beam splitter Bs1 and the polarization beam splitter Bs2 are placed one on the other. The laser light Le emitted from the light-intensity distribution correction optical system 67 enters the polarization beam splitter Bs1. Then, a p-polarization component (indicated with sign P in the diagram) of the laser light Le is transmitted through the polarization beam splitter Bs1, and an s-polarization component (indicated with sign S in the diagram) of the laser light Le is reflected by a beam split surface Mb1. The laser light Le including the s-polarization component reflected by the beam split surface Mb1 enters the polarization beam splitter Bs2. Then, the laser light Le is reflected by a beam split surface Mb2 of the polarization beam splitter Bs2. The laser light Le reflected by the beam split surface Mb2 is transmitted through the ½ wavelength plate Hc2 placed on the emission surface of the polarization beam splitter Bs2, and the polarization direction of the laser light Le is rotated by 90 degrees. Accordingly, the laser light Le becomes p-polarization and the laser light Le is emitted. Then, the laser light Le that has a uniform polarization direction, which has been emitted through each of the polarization beam splitter Bs1 and the light beam splitter Bs2, is emitted toward the mirror 69.

### <DMD 80>

The DMD 80 includes a multiplicity of micromirrors 82 arranged in a grid form (for example, 1024×768 micromirrors or the like). Each of the micromirrors 82 forms a pixel. In this apparatus, each of the micromirrors 82 corresponds to each pixel of a two-dimensional pattern formed by exposing a material 30 for printed circuit boards to light. Each of the micromirrors 82 is separately controlled based on the value of data generated for each of the pixels. Since the micromirrors 82 are controlled in such a manner, the laser light Le that has entered each of the micromirrors 82 is reflected in one of an exposure direction and a non-exposure direction. The exposure direction is a direction toward an optical path for exposing the material 30 for printed circuit boards to light, and the non-exposure direction is a direction different from the exposure direction. Then, only the laser light reflected in the exposure direction is transmitted through a predetermined optical path and used to expose a photosensitive material 30K in the material 30 for printed circuit boards to light. Specifically, the photosensitive material 30K is exposed to light in a desirable two-dimensional pattern by controlling each of the multiplicity of micromirrors 82 in such a manner that the laser light Le is reflected in the exposure direction (ON) or in the non-exposure direction (OFF).

As illustrated in FIG. 4, the multiplicity of micromirrors 82 are arranged on a SRAM cell (memory cell) 83, and each of the very small mirrors (micromirrors) 82 is supported by a support post. The multiplicity of micromirrors (for example, 1024×768) for forming the picture elements (pixels) of an image of a two-dimensional pattern are arranged in a grid form. Further, a material, such as aluminum, that has a high reflectance is deposited on the surfaces of the micromirrors 82, and the reflectances of the micromirrors 82 are greater than or equal to 90%. The SRAM cell 83 of silicon-gate CMOS, which is produced in an ordinary production line of semiconductor memories, is arranged exactly under the micromirrors 82 through support posts, each including a hinge and a yoke, and the whole DMD is monolithically formed.

When a digital signal is written in the SRAM cell 83 of the DMD 80, the micromirrors 82 supported by the support posts are inclined within the range of ±α degrees (for example, ±10 degrees) with respect the diagonal line of each of the micromirrors 82. FIG. 5A is a diagram illustrating an ON state of a micromirror 82, in which the micromirror 82 is inclined at +α degrees. FIG. 5B is a diagram illustrating an OFF state of a micromirror 82, in which the micromirror 82 is inclined at −α degrees. Therefore, if the inclination angle of the micromirror 82 at each pixel of the DMD 80 is controlled as illustrated in FIG. 5, the laser light Le that has entered the DMD 80 is reflected in a direction corresponding to the inclination angle of each of the micromirrors 82. Specifically, the laser light Le is reflected in the exposure direction or in the non-exposure direction.

The ON/OFF control of the micromirrors 82 is performed by a controller 302 connected to the DMD 80. The controller 302 will be described later. Further, the amount of the laser light with which the photosensitive material 30K of the material 30 for printed circuit boards is irradiated can be controlled by changing a ratio between a time period during which a micromirror is turned on and a time period during which the micromirror is turned off per unit time.

Next, partial use of the micromirrors 82 will be described. As illustrated in FIGS. 6A and 6B, in the DMD 80, 1024 micromirrors (pixels) are arranged in a main scan direction for exposure, which is a column direction, and 756 micromirrors (pixel columns) are arranged in a sub-scan direction for exposure, which is a row direction. However, in this example, the controller controls the micromirrors 82 so that only a part of the columns of the micromirrors (for example, 1024 columns×300 rows) are driven.

For example, as illustrated in FIG. 6A, only a matrix area 80C positioned at a central part of 756 rows of micromirrors 82 with respect to the row direction may be controlled. Alternatively, as illustrated in FIG. 6B, only a matrix area 80T positioned at an end of the micromirrors 82 with respect to the row direction may be controlled. When the DMD 80 is controlled, the data processing speed is limited. As the number of micromirrors (pixels) to be controlled increases, the modulation speed of each of the micromirrors 82 becomes lower. Therefore, if only a part of the micromirrors 82 are used, it is possible to increase the modulation speed of each of the micromirrors 82 included in the part.

### <Imaging Optical System>

As illustrated in FIG. 1, in an imaging optical system 51, the first imaging optical system 51A including lens systems 52 and 54, a microlens array 55, an aperture array 59 and the second imaging optical system 51B including lens systems 57 and 58 are arranged in this order from the upstream side toward the downstream side of the optical path. In the microlens array 55, microlenses 55a, which pass light beams corresponding to the micromirrors 82, are arranged. The light beams corresponding to the micromirrors 82 are light beams reflected by the respective micromirrors 82 of the DMD 80 and transmitted through the first imaging optical system 51A. As the microlenses 55a, microlenses that have a focal length of 0.19 mm and NA (numerical aperture) of 0.11 may be used, for example. Further, the aperture array 59 includes a multiplicity of apertures 59a, which are formed so as to correspond to the microlenses 55a in the microlens array 55.

It is desirable that the first imaging optical system forms an image of each of light beams corresponding to the pixel units on one flat plane orthogonal to the direction of the light axis of the optical path for forming an image of a two-dimensional pattern on the photosensitive material 30K. The light beams corresponding to the pixel units are light beams on which spatial light modulation has been performed by the spatial light modulation means (80). Further, it is desirable that the second imaging optical system forms an image of each of the light beams, of which the images have been formed by the first imaging optical system, one more time on one flat plane orthogonal to the direction of the light axis.

The first imaging optical system 51A magnifies an image formed by the DMD 80 three times and forms the magnified image in the microlens array 55. Then, the second imaging optical system 51B magnifies the image formed in the microlens array 55 1.67 times and forms the magnified image on the photosensitive material 30K of the material 30 for printed circuit boards. Therefore, as the whole imaging optical system 51, a two-dimensional pattern on which spatial light modulation has been performed by the DMD 80 is magnified five times and the magnified image is formed on the photosensitive material 30K of the material 30 for printed circuit boards.

Further, the material 30 for printed circuit boards is conveyed by a stage drive apparatus, which will be described later, in the sub-scan direction (a direction perpendicular to the paper surface of FIG. 1, Y direction in FIG. 1).

### <Imaging Position Correction Means 40>

The imaging position correction means 40 includes a first imaging position correction unit 40A and a second imaging position correction unit 40B. The first imaging position correction unit 40A is a liquid crystal device for correcting the imaging position of each of light beams of which images are formed by the first imaging optical system 51A. Further, the second imaging position correction unit 40B is a liquid crystal device for correcting the imaging position of each of light beams of which images are formed by the second imaging optical system 51B. The imaging position correction means 40 may include only one of the first imaging position correction unit 40A and the second imaging position correction unit 40B.

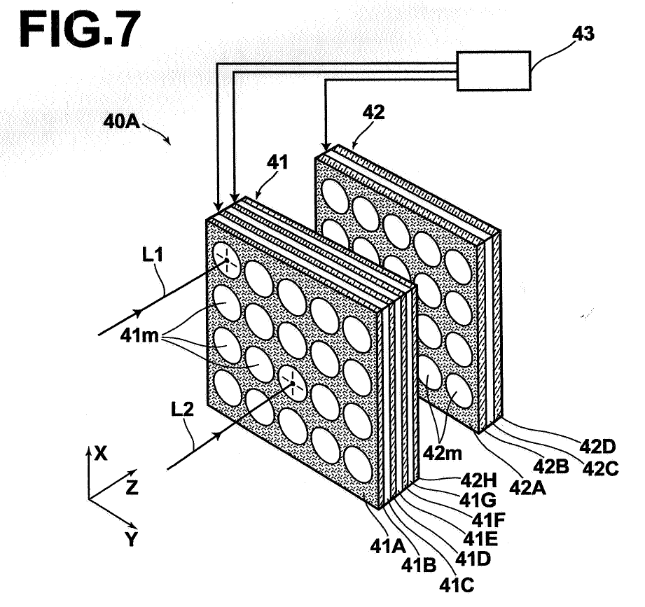

FIG. 7 is a schematic enlarged perspective view illustrating the configuration of the first imaging position correction unit 40A.

The first imaging position correction unit 40A is placed between the first imaging optical system 51A and the microlens array 55. The first imaging position correction unit 40A includes a shift-direction correction device 41, a focus-direction correction device 42 and a voltage application unit 43. The shift-direction correction device 41 is formed by depositing two liquid crystal layers 41C and 41G one on the other. The focus-direction correction device 42 is formed by a single liquid crystal layer 42B. The voltage application unit 43 applies voltage for forming an electric field in each of the liquid crystal layers of the shift-direction correction device 41 and the focus-direction correction device 42. The shift-direction correction device 41 and the focus-direction correction device 42 may be arranged to be spaced from each other, as illustrated in FIG. 7. Alternatively, the shift-direction correction device 41 and the focus-direction correction device 42 may be arranged to be in close contact with each other. Further, these devices may be united by attaching them to each other using an adhesive or the like.

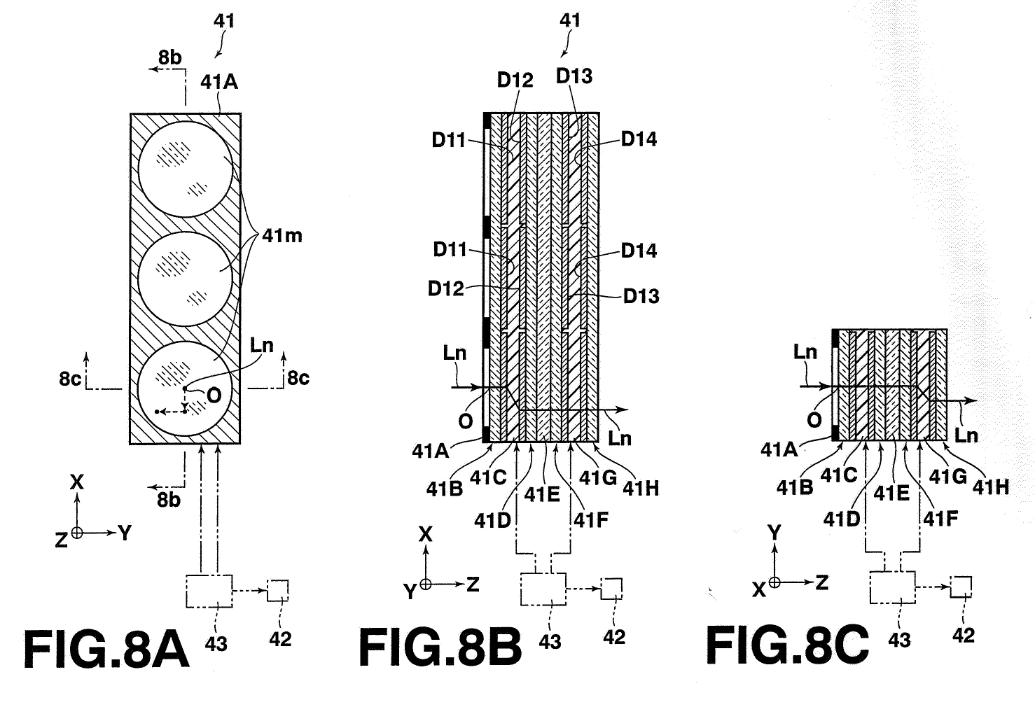

FIG. 8A is a diagram illustrating a part of the shift-direction correction device 41, viewed from the upstream side of the optical path through which the light beams propagate. FIG. 8B is a diagram illustrating a cross section 8b-8b of FIG. 8A. FIG. 8C is a diagram illustrating a cross section 8c-8c of FIG. 8A.

As illustrated in the diagrams, in the shift-direction correction device 41, an aperture array plate 41A, a glass plate 41B, a liquid crystal layer 41C, a glass plate 41D, a 90-degrees optical rotation plate 41E, a glass plate 41F, a liquid crystal layer 41G and a glass plate 41H are deposited one on another in this order from the upstream side of the optical path. The liquid crystal layers 41C and 41G are made of liquid crystal, and the aperture array plate 41A has openings 41m corresponding to the microlenses 55a in the microlens array 55.

Electrodes D11 corresponding to the openings 41m are arranged on the liquid-crystal-layer-41C-side surface of the glass plate 41B. Further, electrodes D12 corresponding to the electrodes D11 (openings 41m) are arranged on the liquid-crystal-layer-41C-side surface of the glass plate 41D. The voltage application unit 43 applies a voltage between the electrodes D1 and D12 and an electric field is formed in the liquid crystal layer 41C. Consequently, the orientation of the liquid crystal present between electrodes that correspond to each other is changed, and a gradient of refractive indices is generated in a liquid crystal area between the electrodes.

Further, in a manner similar to the aforementioned arrangement, electrodes D13 corresponding to the openings 41m are arranged on the liquid-crystal-layer-41G-side surface of the glass plate 41F. Further, electrodes D14 corresponding to the electrodes D13 (openings 41m) are arranged on the liquid-crystal-layer-41G-side surface of the glass plate 41H. The voltage application unit 43 applies a voltage between the electrodes D13 and D14 and an electric field is formed in the liquid crystal layer 41G. Consequently, the orientation of the liquid crystal present between electrodes that correspond to each other is changed, and a gradient of the refractive indices is generated in a liquid crystal area between the electrodes. In other words, a distribution of refractive indices is generated in the liquid crystal area.

Accordingly, it is possible to shift a light beam Ln that has entered the center O of the opening 41m at an angle perpendicular to the surface of the glass plate 41B (the direction of arrow Z in the diagrams) to a direction parallel to the surface of the glass plate 41B (the direction of arrows X-Y flat surface in the diagrams), for example. In other words, it is possible to shift the light beam Ln that has entered the center O of the opening 41m at the angle perpendicular to the surface of the glass plate 41B to a direction orthogonal to the direction of the light axis of an optical path for forming an image of a two-dimensional pattern on the photosensitive material 30K. Then, it is possible to emit the shifted light beam Ln from the glass plate 41H. Further, as the liquid crystal that is used here, a vertically-oriented liquid crystal is known.

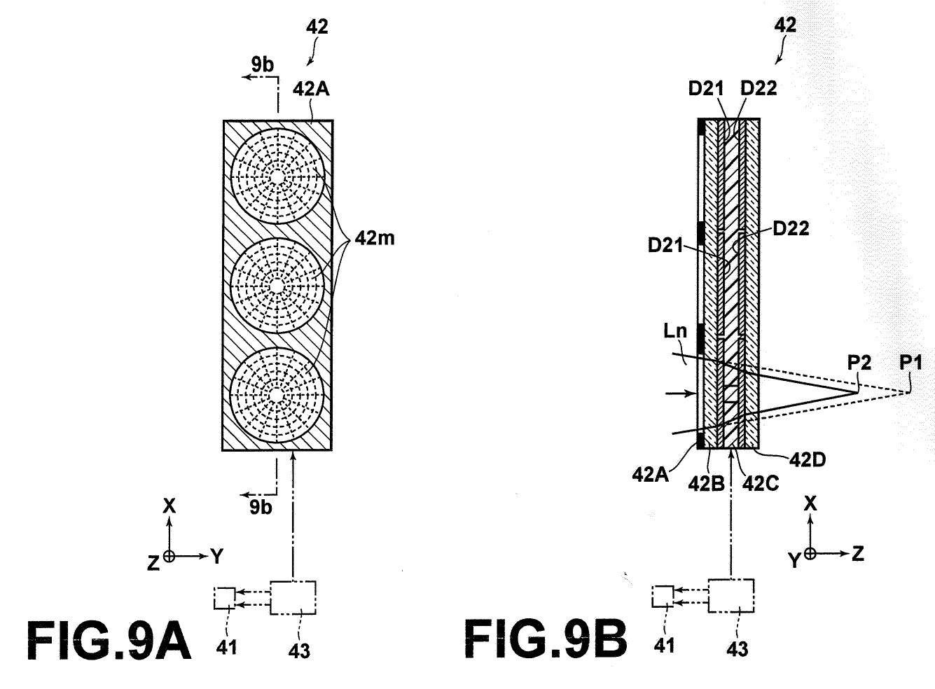

FIG. 9A is a diagram illustrating a part of the focus-direction correction device 42, viewed from the upstream side of the optical path of the light beam. FIG. 9B is a diagram illustrating a cross section 9b-9b of FIG. 9A.

As illustrated in the diagrams, in the focus-direction correction device 42 placed on the downstream side of the shift-direction correction device 41, an aperture array plate 42A, a glass plate 42B, a liquid crystal layer 42C, made of liquid crystal, and a glass plate 42D are deposited one on another in this order from the upstream side of the optical path. The aperture array plate 42A has openings 42m corresponding to the microlenses 55a in the microlens array 55. Since the shift-direction correction device 41 has the aperture array plate 41A, it is not necessary that the focus-direction correction device 42 has an aperture array plate 42A.

Electrodes D21 corresponding to the openings 42m are arranged on the liquid-crystal-layer-42C-side surface of the glass plate 42B. Further, electrodes D22 corresponding to the electrodes D21 (openings 42m) are arranged on the liquid-crystal-layer-41C-side surface of the glass plate 42D. Each of the electrodes D21 and D22 has a plurality of electrode portions formed by dividing each of the electrodes into ring zones. The voltage application unit 43 applies a voltage to each of electrode portions between the electrodes D21 and D22 that correspond to each other, and electric fields that are different from each other are formed between the electrode portions. The orientation of the liquid crystal present between the electrodes is changed, and a distribution of refractive indices is generated so that the liquid crystal area between the electrodes has a convex lens or concave lens function.

Accordingly, it is possible to move the imaging position of a light beam that enters the opening 42m in a direction perpendicular to the surface of the glass plate 42B (the direction of arrow Z in the diagrams). In other words, it is possible to move the imaging position in the direction of the light axis of the optical path for forming an image of a two-dimensional pattern on the photosensitive material 30K. Consequently, it is possible to move the imaging position of the light beam Ln entering the opening 42m in a condensing state from a position P1 to a position P2 along the direction of the light axis (the direction of arrow Z in the diagrams), for example. Further, as the liquid crystal that is used here, a vertically-oriented liquid crystal is known.

Further, as the shift-direction correction device 41 and the focus-direction correction device 42, a device that has the structure and the action described in “Technology Focus”, E Express, pp. 24-27, Apr. 15, 2004, “Optical Path Shift Device Utilizing the Vertically Aligned Ferroelectric Liquid Crystal”, Ricoh Technical Report No. 28, pp. 12-19, 2002 or the like may be adopted.

As described above, the imaging position of each of light beams L1, L2 . . . , on which spatial light modulation has been performed by the DMD 80, and which have been transmitted through the first imaging optical system 51A, is moved in the direction of the light axis or in a direction orthogonal to the direction of the light axis by the first imaging position correction unit 40A. Therefore, it is possible to cause each of the light beams L1, L2 . . . to accurately enter the respective microlenses 55a.

Further, after voltages applied between the electrodes of the shift-direction correction device 41 and those of the focus-direction correction device 42 are determined by the voltage application unit 43 so that each of the light beams L1, L2 . . . accurately enters the respective microlenses 55a, each of the voltages is fixed by the voltage application unit 43 and the imaging position of each of the light beams is fixed.

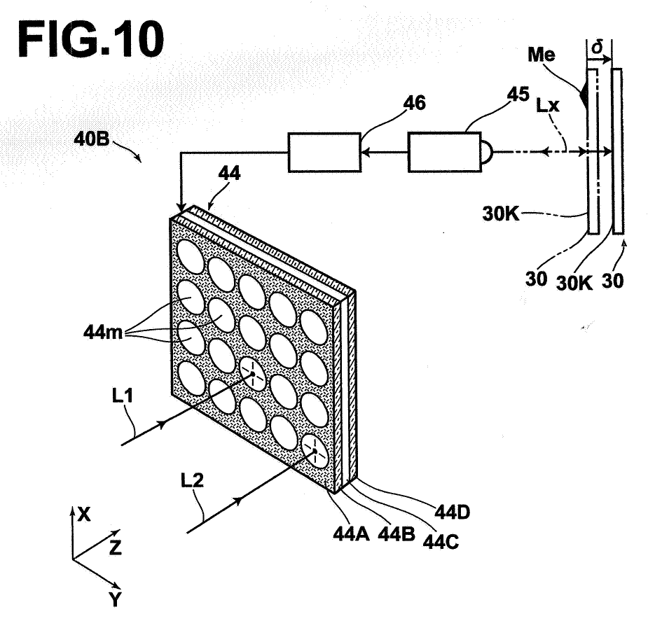

FIG. 10 is a schematic enlarged perspective view illustrating the configuration of the second imaging position correction unit 40B.

The second imaging position correction unit 40B includes a focus-direction correction device 44, a position variation measurement unit 45 and a focus control unit 46. The focus-direction correction device 44 is placed between the second imaging optical system 51B and the photosensitive material 30K, and includes a single liquid crystal layer 44C. The position variation measurement unit 45 measures a variation (the variation is indicated with δ in the diagram) of the position of the photosensitive material 30K in the direction of the light axis from an imaging plane for forming an image of each of the light beams L1, L2 . . . by the second imaging optical system 51B, the imaging plane having been set in advance. The imaging plane that has been set in advance is, in other words, a predetermined plane (indicated with sign Me in the diagram) on which the photosensitive material 30K of the printed circuit board material 30 should be placed. The focus control unit 46 corrects, based on the measurement result of the variation in the position obtained by the position variation measurement unit 45, the imaging position of each of the light beams by the second imaging optical system separately for each of the light beams. The focus control unit 46 corrects the imaging position of each of the light beams by the second imaging optical system so that an image of a two-dimensional pattern formed on the photosensitive material 30K coincides with an intended two-dimensional pattern.

Further, the position variation measurement unit 45 may measure the variation 5 of the position of the photosensitive material 30K by using a known laser length method or the like. In the laser length method, the variation δ of the position is measured by irradiating the photosensitive material 30K with laser light Lx and by analyzing a reflection component of the laser light Lx reflected by the photosensitive material 30K.

The focus-direction correction device 44 has a structure and a function substantially similar to those of the focus-direction correction device 42, which has already been described. Specifically, in the focus-direction correction device 44, an aperture array plate 44A, a glass plate 44B, a liquid crystal layer 44C, made of liquid crystal, and a glass plate 42D are deposited one on another in this order from the upstream side of the optical path. The aperture array plate 44A has openings 44m positioned so as to correspond to positions through which the light beams L1, L2 . . . emitted from the second imaging optical system 51B. Further, electrodes corresponding to the openings 44m are arranged on the liquid-crystal-layer-44C-side surface of the glass plate 44B and on the liquid-crystal-layer-44C-side surface of the glass plate 44D. The focus control unit 46 applies a voltage between the electrodes to generate an electric field. Consequently, the orientation of the liquid crystal present between the electrodes is changed in a manner similar to the manner described above, and a distribution of refractive indices is generated so that this liquid crystal area has a convex lens or concave lens function.

Then, the focus control unit 46 controls the focus-direction correction device 44 based on the measurement result of the variation of the position obtained by the position variation measurement unit 45 and moves the imaging position of each of the light beams L1, L2 . . . entering the openings 44m separately for each of the light beams in the direction of the light axis. Accordingly, an image J2 of a two-dimensional pattern formed on the photosensitive material 30K coincides with an intended two-dimensional pattern.

Even if the variation of the position of the photosensitive material 30K in the direction of the light axis is different at each portion of the photosensitive material 30K, in other words, even if the photosensitive material 30K is wrinkled, if the position variation measurement unit 45 measures a variation at each of a plurality of positions of the photosensitive material 30K that are different from each other, it is possible to cause an image J2 of a two-dimensional pattern formed on the photosensitive material 30K to coincide with an intended two-dimensional pattern in a manner similar to the aforementioned manner. Specifically, the focus control unit 46 controls the focus-direction correction device 44 based on the measurement results of variations at the plurality of positions on the photosensitive material 30K that are different from each other obtained by the position variation measurement unit 45, and moves the imaging position of each of the light beams L1, L2 . . . entering the openings 44m separately for each of the light beams. Consequently, it is possible to cause an image J2 of a two-dimensional pattern formed on the photosensitive material 30K to coincide with an intended two-dimensional pattern. The position variation measurement unit 45 may measure the variation of the position of the photosensitive material 30K for each position of the photosensitive material 30K at which each of the light beams L1, L2 . . . enters the photosensitive material 30K. Alternatively, the position variation measurement unit 45 may measure the variation of the position for each block formed by dividing the photosensitive material 30K into blocks.

Further, if the variation in the position of the photosensitive material 30K is very small, it is not necessary that the focus-direction correction device 44 is controlled dynamically. Instead, the focus position of each of the light beams L1, L2 . . . may be adjusted by the focus-direction correction device 44 before the photosensitive material is exposed to light and the positions may be fixed in a manner similar to the operation by the focus-direction correction device 42, which has already been described. Specifically, an image-plane curvature aberration or the like of an image of a two-dimensional pattern formed on the photosensitive material by each of the light beams L1, L2 . . . formed by the second imaging optical system 51B may be corrected by the focus-direction correction device 44. In such a case, a voltage application unit for applying a voltage between the electrodes corresponding to the openings 44m of the focus-direction correction device 44 should be provided instead of the position variation measurement unit 45 and the focus control unit 46.

### <<Description of Whole Exposure Apparatus>>

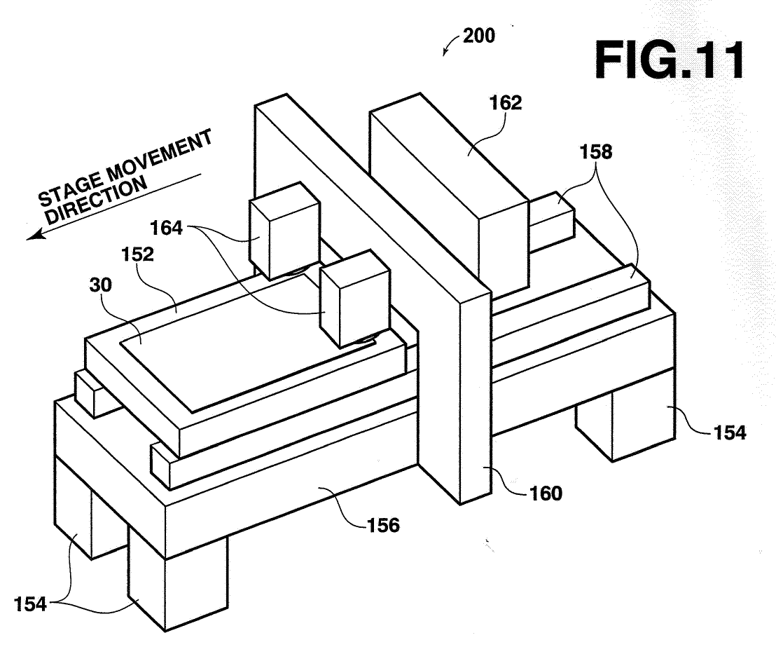

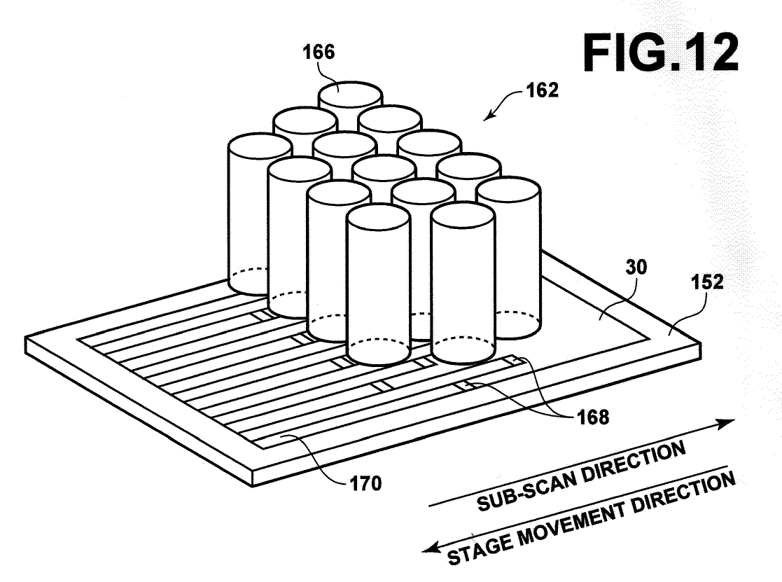

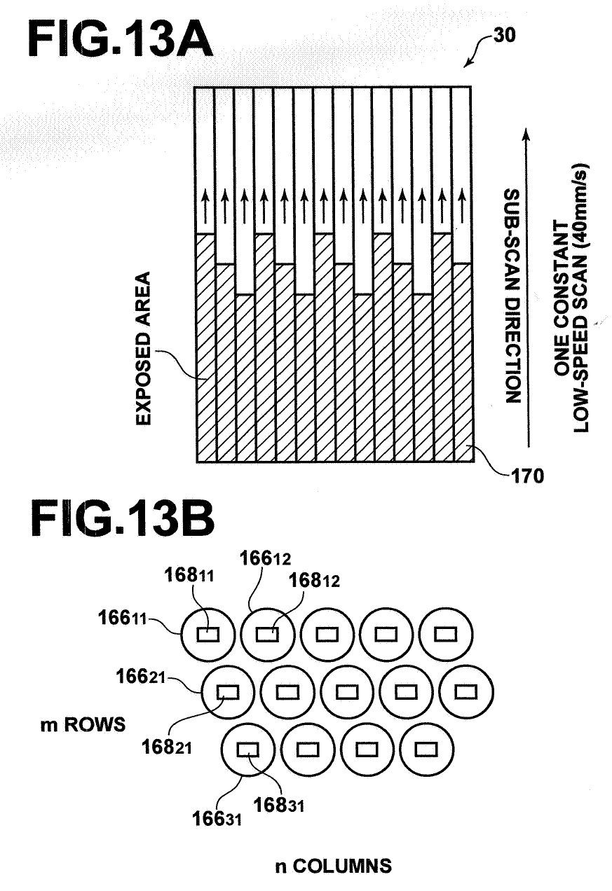

Hereinafter, the whole exposure apparatus will be described. FIG. 11 is a diagram illustrating an external perspective view of the exposure apparatus. FIG. 12 is a perspective view illustrating a process of exposing a photosensitive material to light using an exposure head. FIG. 13A is a plan view illustrating an exposure area formed on the photosensitive material. FIG. 13B is a diagram illustrating a positional relationship between exposure areas by respective exposure heads.

The exposure apparatus 200 includes a moving stage 152 that has a flat plate shape. The moving stage 152 holds the material 30 for printed circuit boards by sucking a back side (the reverse side of a photosensitive-material-30K-side surface) thereof. A base 156 that has a thick plate shape is supported by four legs 154, and two guides 158 extending along the stage movement direction are provided on the upper surface of the base 156. The stage 152 is placed in such a manner that the longitudinal direction of the stage 152 is directed to the direction of the stage movement. Further, the stage 152 is supported by the guides 158 so as to allow forward and backward movements of the stage 152. Further, in the exposure apparatus, a stage drive apparatus (not illustrated) is provided to drive the stage 152 as a sub-scan means along the guides 158 in the direction of the stage movement.

At a central part of the base 156, a Japanese-KO-shaped gate 160 is provided in such a manner that the gate straddles the movement path of the stage 152. Further, each end of the Japanese-KO-shaped gate 160 is fixed onto either side of the base 156. A scanner 162 is provided on one side of the gate 160 and a plurality of sensors 164 (for example, two sensors) are provided on the other side of the gate 160. The sensors 164 detect a leading edge and a rear edge of the material 30 for printed circuit boards. Each of the scanner 162 and the sensors 164 is attached to the gate 160, and fixed at a position over the movement path of the stage 152. Further, the scanner 162 and the sensors 164 are connected to a controller for controlling the scanner 162 and the sensors 164, which is not illustrated.

The scanner 162 includes a plurality (for example, 14) exposure heads 166, as illustrated in FIG. 12 and FIG. 13B. The plurality of exposure heads 166 are arranged substantially in a matrix form of m rows×n columns (for example, 3 rows×5 columns). In this example, five exposure heads 166 are placed in the first row and in the second row, and four exposure heads 166 are placed in the third row because of the relation to the width of the material 30 for printed circuit boards. Please note that an exposure head positioned in the m-th row of the n-th column is represented by an exposure head 166ₘₙ.

An exposure area 168 formed by the exposure head 166 has a rectangular shape with a shorter side of the rectangular shape directed in the sub-scan direction. Therefore, when the stage 152 moves, a band-shaped exposed area 170 is formed on the material 30 for printed circuit boards by each of the exposure heads 166. Please note that an exposure area formed by an exposure head positioned in the m-th row of the n-th column is represented by an exposure area 168ₘₙ.

Further, as illustrated in FIGS. 13A and B, each of the exposure heads linearly arranged in each row are shifted by a predetermined distance (a value obtained by multiplying the length of the longer side of an exposure area by a natural number, and in this example, a value obtained by multiplying the length by two) in the arrangement direction of the exposure heads so that the band-shaped exposed areas 170 are formed without space therebetween n a direction orthogonal to the sub-scan direction. Therefore, an unexposed area between an exposed area 168₁₁ and an exposure area 168₁₂ in the first row is exposed to light by an exposure area 168₂₁ in the second row and an exposure area 168₃₁ in the third row.

Each of exposure heads 166₁₁ through 166ₘₙ includes a DMD 80 for modulating, based on image data, laser light entering the DMD 80 for each pixel, as described above. Each of the exposure heads 166 is connected to a controller 302, which will be described later. The controller 302 includes a data processing unit and a mirror drive control unit. The data processing unit generates a control signal for controlling each of micromirrors of the DMD 80 based on input data representing a circuit pattern. Further, the mirror drive control unit turns each of the micromirrors of the DMD 80 on or off based on the control signal generated by the data processing unit.

### <<Description of Electrical Configuration of Exposure Apparatus>>

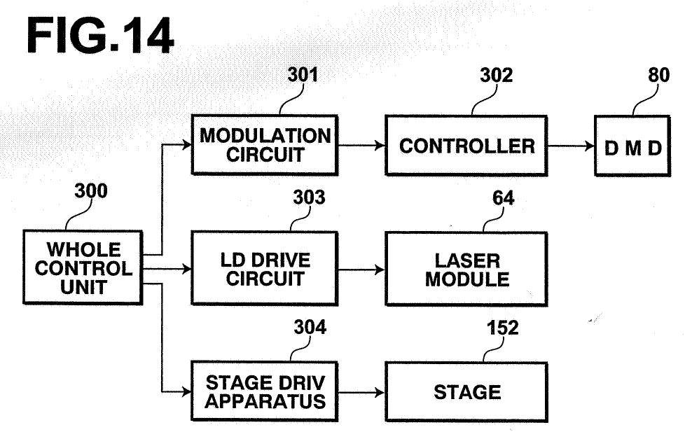

Next, the electrical configuration of the exposure apparatus 200 will be described. FIG. 14 is a block diagram illustrating the electrical configuration of the exposure apparatus.

As illustrated in the diagram, a modulation circuit 301 is connected to a whole control unit 300. The modulation circuit 301 obtains image data representing a circuit pattern. Further, a controller 302 for controlling the DMD 80 is connected to the modulation circuit 301. Further, an LD (Laser Diode) drive circuit 303 for driving a laser module provided in the light source 66 is connected to the whole control unit 300. Further, a stage drive apparatus 304 for driving the stage 152 is connected to the whole control unit 300.

### <<Description of Operations of Exposure Apparatus>>

Next, the operations of the exposure apparatus 200 will be described.

When the photosensitive material 30K deposited in the material 30 for printed circuit boards is exposed to light using the exposure apparatus 200, a voltage to be applied by the voltage application unit 43 of the first imaging position correction unit 40A between each of electrodes of the shift-direction correction device 41 and each of the focus-direction correction device 42 is determined in advance so that each of the light beams L1, L2 . . . accurately enters the respective microlenses 55a. After the voltage is determined, the voltage to be applied between the electrodes is fixed.

After then, a light beam of each laser light that has been emitted from a GaN-based semiconductor laser included in the light source 66 in each of the exposure heads 166 of the scanner 162 and combined is emitted from an end of an optical fiber bundle 66A.

When exposure to light in a circuit pattern is performed, the image data is input from the modulation circuit 301 to the controller 302 of the DMD 80, and temporarily stored in a frame memory of the controller 302.

The stage 152, which has sucked the material 30 for printed circuit boards on the surface thereof, is driven by the stage drive apparatus 304 and moves at a constant speed along the guides 158 from the upstream side of the guides 158 to the downstream side of the guides 158. When the stage 152 passes under the gate 160, if the sensors 164 attached to the gate 160 detect the leading edge of the material 30 for printed circuit boards, image data for generating the circuit pattern, which is stored in the frame memory, is read by the data processing unit of the controller 302. Then, the data processing unit generates, based on the image data, a control signal for each of the exposure heads 166. Then, the mirror drive control unit performs, based on the generated control signal, ON/OFF control of each of the micromirrors of the DMD 80 for each of the exposure heads 166. In this example, the size of each of the micromirrors is 14 μm×14 μm.

When the laser light emitted from the light source 66 enters the DMD 80, a light beam reflected by a micromirror 82 of the DMD 80 when the micromirror 82 is in an ON state is transmitted through the imaging optical system 51 and an image of the light beam is formed. Accordingly, an image of a circuit pattern is formed on the photosensitive material 30K in the material 30 for printed circuit boards. Further, each of the exposure areas 168 on the photosensitive material 3 is exposed to light. Further, the material 30 for printed circuit boards is sequentially exposed to light in a sub-scan direction, which is opposite to the direction of the stage movement, by moving the material 30 for printed circuit boards together with the stage 152 at a constant speed in the direction of the stage movement. Consequently, a band-shaped exposed area 170 for each of the exposure heads 166 is formed on the photosensitive material 30K.

Further, when the photosensitive material 30K deposited on the material 30 for printed circuit boards is exposed to light, the position variation measurement unit 45 of the second imaging position correction unit 40B measures a variation in the position of the photosensitive material 30K from a predetermined plane Me for placing the photosensitive material 30K. Then, the focus control unit 46 corrects, based on the measurement result, the imaging position of each of the light beams by the second imaging optical system 51B so that an image of a circuit pattern formed on the photosensitive material 30K coincides with an intended circuit pattern.

If exposure of the material 30 for printed circuit boards to light by the scanner 162 ends and the sensors 164 detect the rear edge of the material 30 for printed circuit boards, the stage 152 is driven by the stage drive apparatus 304 and returns to an origin that is on the most-upstream side of the gate 160 along the guides 158. Accordingly, the exposure apparatus can be used for the next exposure.

The first imaging position correction unit 40A and the second imaging position correction unit 40B have functions for correcting the imaging position of each of the light beams on which spatial light modulation has been performed separately for each of the light beams. Therefore, it is possible to cause the position, the size and the density of each of pixels forming an image of a circuit pattern formed on the photosensitive material to coincide with those of each pixel of pixels forming an intended circuit pattern. As described above, in the present invention, it is possible to more easily correct the imaging position of each of the light beams when an image of a circuit pattern is formed on the photosensitive material.

It is not necessary that the operations by the first imaging position correction unit 40A and the second imaging position correction unit 40B for correcting the imaging position of each of light beams on which spatial light modulation has been performed are performed separately for each of the light beams. The operations may be performed for each block including a plurality of light beams. Specifically, if the correction of the imaging position of each of the light beams is performed for each block, the first imaging position correction unit 40A and the second imaging position correction unit 40B can more easily correct the imaging positions of the light beams. In such a case, the movement direction and the movement amount of the imaging position of each of light beams belonging to a specific block by the first imaging position correction unit 40A become the same as those of the other light beams belonging to the same block. Further, the movement direction and the movement amount of the imaging position of each of light beams belonging to the specific block by the second imaging position correction unit 40B become the same as those of the other light beams belonging to the same block.

Further, the aforementioned correction operations may be performed for the purpose of controlling the position of each of the light beams to smooth edge roughness (an uneven outline of an exposure pattern). The position of each of the light beams is controlled by correcting a two-dimensional pattern, in other words, an exposure pattern.

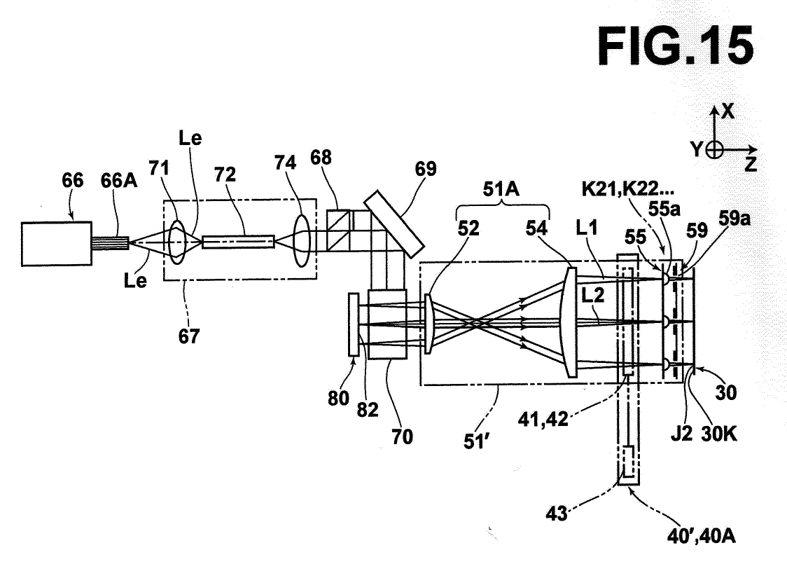

Hereinafter, an exposure apparatus according a second embodiment, which carries out the exposure method of the present invention, will be described with reference to drawings. FIG. 15 is a diagram illustrating an optical path of an optical system of an exposure head included in an exposure apparatus according to the second embodiment.

In the exposure apparatus according to the second embodiment, the second imaging optical system and the second imaging position correction unit have been removed from the configuration in the first embodiment. Specifically, in the exposure apparatus according to the second embodiment, an image of each of light beams transmitted through the respective microlenses after being transmitted through the first imaging optical system is directly formed on the photosensitive material. Therefore, in the exposure apparatus according to the second embodiment, the photosensitive material is exposed to light in an intended two-dimensional pattern by forming an image of a two-dimensional pattern on the photosensitive material without transmitting the light beams through the second imaging optical system. Further, the exposure apparatus according to the second embodiment includes an imaging position correction unit for correcting the imaging position of an image of each of light beams formed by the first imaging optical system separately for each of the light beams.

The exposure apparatus according to the second embodiment has a structure similar to the exposure apparatus according to the first embodiment except the optical system of the exposure head. Therefore, in the drawing, elements other than the optical system are omitted. Further, in the optical system illustrated in FIG. 15, the same signs are used for the elements that have functions similar to those of the first embodiment, and the explanations about the elements are omitted.

As illustrated in FIG. 15, an imaging position correction unit 40′ in the exposure apparatus according to the second embodiment includes only a first imaging position correction unit 40A. The first imaging position correction unit 40A is a liquid crystal device for correcting the imaging position of an image of each of light beams formed by the first imaging optical system 51A. The first imaging position correction unit 40A includes the shift-direction correction device 41, the focus-direction correction device 42 and the voltage application unit 43, as already described. The voltage application unit 43 applies a voltage for forming an electric field in each of liquid crystal layers of the shift-direction correction device 41 and the focus-direction correction device 42. Further, an imaging optical system 51′ for forming an image of each of light beams, on which spatial light modulation has been performed by the DMD 80, on the photosensitive material 30K in the material 30 for printed circuit boards includes only the first imaging optical system 51A, which has already been described.

The first imaging position correction unit 40A moves the imaging position of each of light beams L1, L2 . . . on which spatial light modulation has been performed by the DMD 80, and which has been transmitted through the first imaging optical system 51A, in the direction of a light axis or in a direction orthogonal to the direction of the light axis in a manner similar to the operation in the first embodiment, which has already been described. Consequently, the first imaging position correction unit 40A causes each of the light beams L1, L2 . . . to accurately enter the respective microlenses 55a and directly forms an image of each of the light beams that have been transmitted through the microlenses 55a on the photosensitive material 30K in the material 30 for printed circuit boards. Accordingly, an image of a two-dimensional pattern J2 formed on the photosensitive material 30K coincides with an intended two-dimensional pattern.

Further, the aforementioned correction operations may be performed for the purpose of controlling the position of each of the light beams to smooth edge roughness (an uneven outline of an exposure pattern). The position of each of the light beams is controlled by correcting a two-dimensional pattern, in other words, an exposure pattern.

As described above, the voltage application unit 43 determines the voltage applied between the electrodes of the shift-direction correction device 41 and the focus-direction correction device 42 so that the image of the two-dimensional pattern J2 formed on the photosensitive material 30K coincides with the intended two-dimensional pattern. After the voltage application unit 43 determines the voltage, the voltage application unit 43 fixes each of the voltages and fixes the imaging position of each of the light beams. After then, the material 30 for printed circuit boards is conveyed in the sub-scan direction by the stage drive apparatus according to the first embodiment, and the photosensitive material 30K is exposed to light in a desired two-dimensional pattern.

In the aforementioned embodiment, the GaN-based semiconductor laser was used as the light source in the exposure apparatus 200. Alternatively, a solid state laser, a gas laser or the like for example may be used as the light source. Specifically, a laser formed by combining a YAG laser having a wavelength of approximately 355 nm and SHG, a laser formed by combining a YLF laser having a wavelength of approximately 355 nm and SHG, a laser formed by combining a YAG laser having a wavelength of approximately 266 nm and SHG, an excimer laser having a wavelength of approximately 248 nm, an excimer laser having a wavelength of approximately 193 nm, or the like may be adopted. Further, as the light source, a mercury lamp or the like may be adopted instead of the laser light source.

Further, it is not necessary that the exposure method is used only to form a circuit pattern by exposure. The exposure method may be adopted to form any kind of pattern or image by exposure.

Further, in the aforementioned embodiment, a liquid crystal device, in which a distribution of refractive indices is generated by electrical control, was used as the imaging position correction means, which is an imaging position control means. However, it is not necessary that the imaging position control means is the liquid crystal device. Any kind of method may be adopted in the imaging position control means as long as the imaging position of each of the light beams can be controlled separately for each of the light beams so that the image of the two-dimensional pattern formed on the photosensitive material coincides with the intended two-dimensional pattern.

Further, in the aforementioned embodiment, control related to the position of a light flux, i.e., a light beam, was described. Further, the power of each of the light beams can be changed by combining a liquid crystal device and a polarization plate used in a liquid crystal display. If this feature is utilized, it becomes possible to control the light amount of exposure by each light beam at a relatively low speed. Further, it becomes possible to correct power shading (fluctuation in output) of the exposure head or the like.

1-7. (canceled)

8. An exposure method for exposing a photosensitive material to light in an intended two-dimensional pattern, the method comprising the steps of:
performing spatial light modulation on light, the light being emitted from a light source, by a spatial light modulation means including a multiplicity of two-dimensionally-arranged pixel units for modulating incident light based on a predetermined control signal;
forming an image of each of light beams corresponding to the pixel units, on which the spatial light modulation has been performed by the spatial light modulation means, by passing each of the light beams through a first imaging optical system;
passing each of the light beams separately through a multiplicity of two-dimensionally-arranged micro lenses respectively in the vicinity of the imaging position of each of the light beams, the image of which was formed by passing each of the light beams through the first imaging optical system; and
forming an image of a two-dimensional pattern on the photosensitive material by forming an image of each of the light beams passed separately through the respective microlenses on the photosensitive material by a second imaging optical system, wherein the imaging position of each of the light beams by the first imaging optical system and/or the second imaging optical system is controlled separately for each of the light beams so that the image of the two-dimensional pattern formed on the photosensitive material coincides with the intended two-dimensional pattern.

9. An exposure method for exposing a photosensitive material to light in an intended two-dimensional pattern, the method comprising the steps of:
performing spatial light modulation on light, the light being emitted from a light source, by a spatial light modulation means including a multiplicity of two-dimensionally-arranged pixel units for modulating incident light based on a predetermined control signal;
forming an image of each of light beams corresponding to the pixel units, on which the spatial light modulation has been performed by the spatial light modulation means, by passing each of the light beams through a first imaging optical system; and
passing each of the light beams separately through a multiplicity of two-dimensionally-arranged microlenses respectively in the vicinity of the imaging position of each of the light beams, the image of which was formed by passing each of the light beams through the first imaging optical system, so as to directly form an image of each of the light beams on the photosensitive material, thereby forming an image of a two-dimensional pattern on the photosensitive material, wherein the imaging position of each of the light beams by the first imaging optical system is controlled separately for each of the light beams so that the image of the two-dimensional pattern formed on the photosensitive material coincides with the intended two-dimensional pattern.

10. An exposure apparatus for exposing a photosensitive material to light in an intended two-dimensional pattern, the exposure apparatus comprising:
a light source;
a spatial light modulation means for performing spatial light modulation on light emitted from the light source, the spatial light modulation means including a multiplicity of two-dimensionally-arranged pixel units for modulating the light based on a predetermined control signal;
a first imaging optical system for forming an image of each of light beams corresponding to the pixel units, on which the spatial light modulation has been performed by the spatial light modulation means;
a microlens array including a multiplicity of two-dimensionally-arranged microlenses for separately passing each of the light beams, each of the microlenses being placed in the vicinity of the imaging position of each of the light beams, the image of which was formed by passing each of the light beams through the first imaging optical system;
a second imaging optical system for forming an image of a two-dimensional pattern on the photosensitive material by forming an image of each of the light beams passed separately through the respective microlenses on the photosensitive material; and
an imaging position control means for controlling the imaging position of each of the light beams, the imaging position by the first imaging optical system and/or the second imaging optical system, separately for each of the light beams so that the image of the two-dimensional pattern formed on the photosensitive material coincides with the intended two-dimensional pattern.

11. An exposure apparatus for exposing a photosensitive material to light in an intended two-dimensional pattern, the exposure apparatus comprising:
a light source;
a spatial light modulation means for performing spatial light modulation on light emitted from the light source, the spatial light modulation means including a multiplicity of two-dimensionally-arranged pixel units for modulating the light based on a predetermined control signal;
a first imaging optical system for forming an image of each of light beams corresponding to the pixel units, on which the spatial light modulation has been performed by the spatial light modulation means;
a microlens array including a multiplicity of two-dimensionally-arranged microlenses for separately passing each of the light beams, each of the microlenses being placed in the vicinity of the imaging position of each of the light beams, the image of which was formed by passing each of the light beams through the first imaging optical system, wherein an image of a two-dimensional pattern is formed on the photosensitive material by directly forming an image of each of the light beams passed separately through the respective microlenses on the photosensitive material; and
an imaging position control means for controlling the imaging position of each of the light beams, the imaging position by the first imaging optical system, separately for each of the light beams so that the image of the two-dimensional pattern formed on the photosensitive material coincides with the intended two-dimensional pattern.

12. An exposure apparatus, as defined in claim 10, wherein the imaging position control means moves the imaging position of each of the light beams in the direction of the light axis of an optical path for forming the image of the two-dimensional pattern.

13. An exposure apparatus, as defined in claim 11, wherein the imaging position control means moves the imaging position of each of the light beams in the direction of the light axis of an optical path for forming the image of the two-dimensional pattern.

14. An exposure apparatus, as defined in claim 10, wherein the imaging position control means moves the imaging position of each of the light beams in a direction orthogonal to the direction of the light axis of an optical path for forming the image of the two-dimensional pattern.

15. An exposure apparatus, as defined in claim 11, wherein the imaging position control means moves the imaging position of each of the light beams in a direction orthogonal to the direction of the light axis of an optical path for forming the image of the two-dimensional pattern.

16. An exposure apparatus, as defined in claim 10, wherein the imaging position control means is a liquid crystal device, wherein a distribution of refractive indices is generated in the liquid crystal device by electrical control.

17. An exposure apparatus, as defined in claim 11, wherein the imaging position control means is a liquid crystal device, wherein a distribution of refractive indices is generated in the liquid crystal device by electrical control.
